(19) United States
(12) Patent Application Publication
(10) Pub. No.: US 2010/0066069 A1
(43) Pub. Date: Mar. 18, 2010

(54) HAND CART ATTACHABLE TO A VEHICLE HITCH

(75) Inventor: William R. Bradshaw, Oak Lawn, IL (US)

Correspondence Address: LEMPIA BRAIDWOOD LLC, One North LaSalle Street, CHICAGO, IL, 60602, US

(73) Assignee: Devize Unlimited, Inc., Chicago, IL (US)

(21) Appl. No.: 12/537,434

(22) Filed: Aug. 7, 2009

Related U.S. Application Data
(60) Provisional application No. 61/087,002, filed on Aug. 7, 2008.

(51) Int. Cl. B60R 9/06

(52) U.S. Cl. 280/769

(57) ABSTRACT

A transport device for coupling to a hitch of a vehicle has a frame configured to carry an object, a base on a portion of the frame and located to contact a support surface, and a hitch mount carried by the frame. The hitch mount is arranged so that the base can rest on the support surface and the hitch mount can be positioned adjacent to and contact a coupler of the hitch on the vehicle. The transport device can then be pivoted on the coupler about the hitch mount to raise the base off the support surface and can then be secured to the hitch to be transported by the vehicle. The base can be a wheel such that the transport device can roll up to a hitch, drop down onto the hitch, and then be pivoted up and off the support surface and secured to the hitch.

### RELATED APPLICATION DATA

This patent is related to and claims priority benefit of U.S. provisional application Ser. No. 61/087,002 filed on Aug. 7, 2008 and entitled “Hand Cart Attachable to a Vehicle,” the entirety of which is incorporated by reference herein.

### BACKGROUND OF THE INVENTION

1. Field of the Disclosure

The present disclosure is generally directed to hand carts, dollies, and the like, more particularly to such a device that is easily attachable to a vehicle hitch bar.

2. Description of Related Art

Article carriers are known in the art that can be attached to a vehicle hitch receiver or to a hitch mechanism attached to same. Such article carriers are known to stow articles on the carrier to travel with the vehicle. For example, bike racks and luggage platforms are known that can be mounted to the back of a vehicle on the hitch. A typical carrier has a mounting system or a carrier surface and a mechanism for attaching and detaching the carrier to the vehicle's hitch. However, the articles are typically not stowed or resting on the carrier while the carrier is being installed on or removed from the hitch. Additionally, the carrier and the articles are typically transported and stored separately when the carrier is not attached to the vehicle's hitch.

Additionally, wheeled hand carts, dollies, and the like are known in the art that can be used to move large, heavy, and/or cumbersome objects. A typical hand cart or dolly has wheels at one end and handles at the opposite end. A lift or support leg is typically positioned on the wheel end of the device and projects from the wheel end. A support platform or bearing surface typically extends between the wheel end and the handle end. The support or lift leg is usually oriented normal or perpendicular to the support platform and is placed under the object or articles to be carried. The hand cart or dolly device can be tilted back until the object is resting on the support platform and partly supported by and held in place against the lift leg. The object or articles can be rolled from one location to another without having to carry the full weight of the object or articles. However, the hand cart or dolly device and the object or articles are typically separated from one another for loading onto or into a vehicle for transport by the vehicle. Alternatively, the vehicle might be such that the loaded cart or dolly can be rolled directly inside of the vehicle for transport.

### BRIEF DESCRIPTION OF THE DRAWINGS

Objects, features, and advantages of the present invention will become apparent upon reading the following description in conjunction with the drawing figures, in which:

FIG. 1 shows a perspective view of one example of a transport device such as a hand truck, dolly or cart constructed in accordance with the teachings of the present invention and mounted to a vehicle.

FIG. 2 shows the transport device in FIG. 1 in an alternate, optional configuration.

FIG. 3 shows the transport device in FIG. 2 being pushed by a user.

FIG. 4 shows a side view of the transport device in FIGS. 2 and 3.

FIG. 5 shows the transport device in FIG. 4 in an alternate use orientation.

FIG. 6 shows the transport device in FIGS. 2-5, but in the configuration of FIG. 1 and being pushed by a user.

FIG. 7 shows an exploded perspective view of one example of a hitch adapter for a vehicle hitch and constructed in accordance with the teachings of the present invention.

FIG. 8 shows a bottom view of a mounting portion of the transport device in FIG. 1, partially removed from the hitch adapter.

FIG. 9 shows a perspective view of the transport device in FIG. 1 in a ready position adjacent the hitch adapter on a vehicle hitch.

FIG. 10 shows the transport device in FIGS. 1 and 9, but lowered onto the hitch adapter.

FIG. 11 shows the transport device in FIGS. 1 and 10, but with the wheels tipped up and the device ready to slide onto the hitch adapter.

FIG. 12 shows an exploded perspective view of another example of a hitch adapter for a transport device and constructed in accordance with the teachings of the present invention.

FIG. 13 shows the transport device in FIG. 1 mounted to a vehicle using an alternate example of a hitch adapter constructed in accordance with the teachings of the present invention.

FIG. 14 shows an exploded perspective view of a portion of the transport device and the hitch adapter in FIG. 13.

FIG. 15 shows a side view of an alternate example of a mounting portion for the transport device in FIG. 1.

FIG. 16 shows an exploded perspective view another example of a hitch adapter and transport device mount constructed in accordance with the teachings of the present invention.

FIGS. 17 and 18 show exploded perspective views of optional use arrangements for a transport device constructed in accordance with the teachings of the present invention.

FIG. 19 shows an end portion of another example of a transport device with a ramp constructed in accordance with the teachings of the present invention.

FIG. 20 shows a perspective view of another example of a transport device constructed in accordance with the teachings of the present invention.

FIG. 21 shows a side view of the transport device in FIG. 20.

FIG. 22 shows a perspective view of the transport device in FIGS. 20 and 21 and positioned adjacent a vehicle hitch and lowered onto the hitch adapter.

FIG. 23 shows a side view of the transport device in FIG. 22, but with the wheels tipped up and mounted to the vehicle hitch.

FIG. 24 shows an exploded perspective view of another example of a hitch adapter for a transport device and constructed in accordance with the teachings of the present invention.

FIG. 25 shows a side view of the hitch adapter in FIG. 24 and in an adjustable orientation.

FIG. 26 shows the hitch adapter in FIG. 25 oriented in a selected position.

FIG. 27 shows an exploded perspective view of another example of a transport device and hitch adapter constructed in accordance with the teachings of the present invention.

FIG. 28 shows a partially exploded perspective view of another example of a transport device and hitch adapter constructed in accordance with the teachings of the present invention.

FIG. 29 shows the transport device in FIG. 28 mounted to the hitch adapter.

FIG. 30 shows the transport device in FIG. 28 in a ready to use configuration.

FIG. 31 shows a partially exploded perspective view of another example of a transport device and hitch adapter constructed in accordance with the teachings of the present invention.

FIG. 32 shows a close-up perspective view of the hitch adapter in FIG. 31.

FIG. 33 shows the transport device in FIG. 31 mounted to the hitch adapter.

FIG. 34 shows an exploded perspective view of another example of a transport device and hitch adapter constructed in accordance with the teachings of the present invention.

FIG. 35 shows a cross section taken along line A-A in FIG. 34 of the transport device mounted to the hitch adapter.

FIG. 36 shows an alternate example of the transport device mounted to an alternate example of a hitch adapter.

### DETAILED DESCRIPTION OF THE DISCLOSURE

The disclosed transport devices and hitch adapters solve or improve upon one or more of the above-noted and/or other problems and disadvantages with known article carriers, dollies, hand trucks, carts, and the like. The disclosed transport devices can be utilized to load and push or pull objects and articles in a conventional manner, including large sized, heavy, awkwardly shaped objects. The disclosed transport devices, already loaded with items to transport, can also be rolled, pushed, pulled, or slid up to a hitch adapter mounted to a vehicle's hitch receiver. The transport device and items on the device can then be easily and quickly mounted directly to the hitch adapter for ready transport by the vehicle. The disclosed transport devices can also be easily and quickly detached from the tow bar and then be immediately ready to move with the items already carried on the device.

In accordance with the teachings of the present invention, items can be carried by and remain attached to any one of the disclosed transport devices: 1) prior to the transport device being mounted to the hitch adapter; 2) while the cart is being mounted to the vehicle's hitch; 3) while the transport device is being towed by the vehicle; 4) while the transport device is being detached from the vehicle's hitch; and 5) after the cart has transport device been detached from the hitch adapter. The disclosed transport devices and accessories can be used by hunters to haul big game, by movers or individuals to haul boxes, appliances, and the like, by travelers to carry excess luggage, and by many others for a wide variety of different purposes.

As used herein, transport device generally identifies a dolly, a hand truck, a cart, a pushcart, a barrow, a dray, a gurney, a handcart, a tumbrel, a wagon, a wheelbarrow, or the like. The term “cart’ is used interchangeably herein with transport device to generically identify these types of transport devices. The invention is not intended to be limited to any particular type of transport device. Most of these types of devices have wheels. However, as will become evident to those having ordinary skill in the art, a device can also function according to the teachings of the present invention utilizing sliders, rollers, skids, skis, and the like. The term base as used herein refers to a portion of the device that supports the device on a ground or support surface. The wheel or wheels in most cases are the base, but the base can again refer to sliders, rollers, skids, skids, and the like.

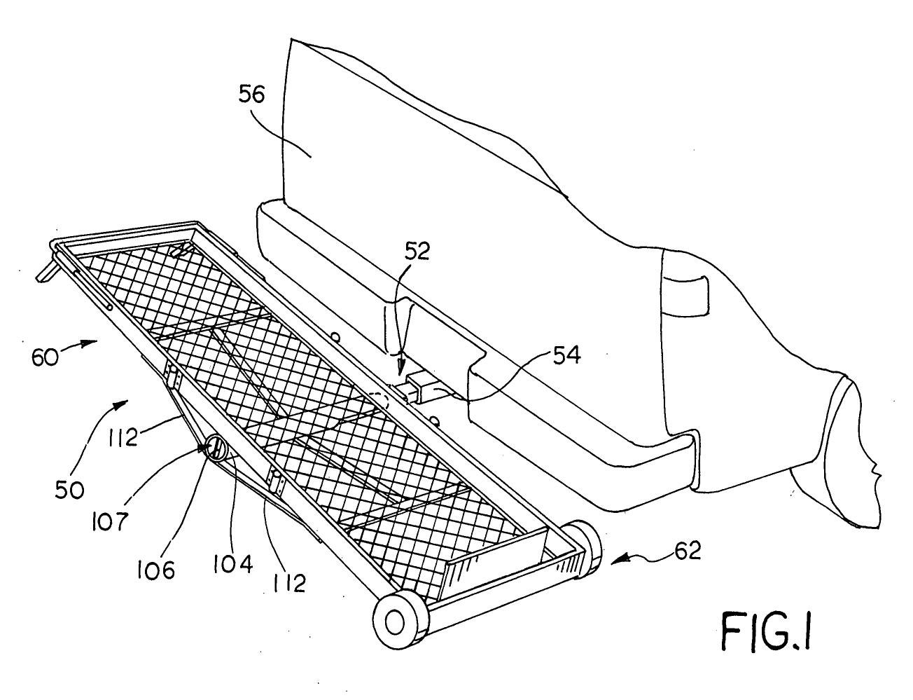

Turning now to the drawings, FIG. 1 shows one example of a cart 50 and a hitch adapter 52 mounted to a hitch receiver 54 on a vehicle 56 in accordance with the teachings of the present invention. As shown in FIG. 1, the cart 50 can be mounted to the vehicle hitch and towed or transported behind the vehicle 56 when mounted to the hitch without any part of the cart touching the ground.

In general, the disclosed cart 50 has a frame 60 configured to support and carry one or more objects or articles. The cart 50 also has a base 62 mounted to a portion of the frame. The base 62 is arranged so that it can be located to contact a ground or a support surface. In this example, the frame 60 has a plurality of structural rails including a transverse handle rail 64 at an upper or handle end of the frame. The frame 60 also has a pair of elongate, spaced apart side rails 66 extending lengthwise from the handle rail 64 to a transverse foot rail 68 at a bottom or foot and of the cart. In this example, the rail structure defines a perimeter for a perforate grid plate or platform 70 of the frame. The platform 70 defines a planar bearing surface configured to support and/or carry articles or objects. In this example, the rails 64, 66, and 68 are channels and can be formed of steel or other suitable materials to impart rigidity and strength to the cart 50 as needed. The frame 60 can also include one or more longitudinally spaced apart cross braces 71, which can assist to support the platform 70 as well as to impart additional strength and rigidity to the frame structure.

As will be evident to those having ordinary skill in the art, the particular frame configuration, geometry, and materials used can vary and yet function as intended within the spirit and scope of the present invention. The platform or support surface of the cart can be a solid platform, a wire mesh surface, a planar surface, a curved contoured surface, a removable surface, an integral surface, and/or the like.

The frame 60 in this example also has a foot plate 72 at the foot end of the cart 50. The foot plate 72 projects forward from the foot rail 68 and is oriented generally normal or perpendicular to the platform 70. The foot plate 72 can be positioned under an object or article to be carried and then the cart 50 can be tipped so that the articles will lie on the platform 70. The platform is configured so that articles can be placed or set directly on the platform to be carried by the cart.

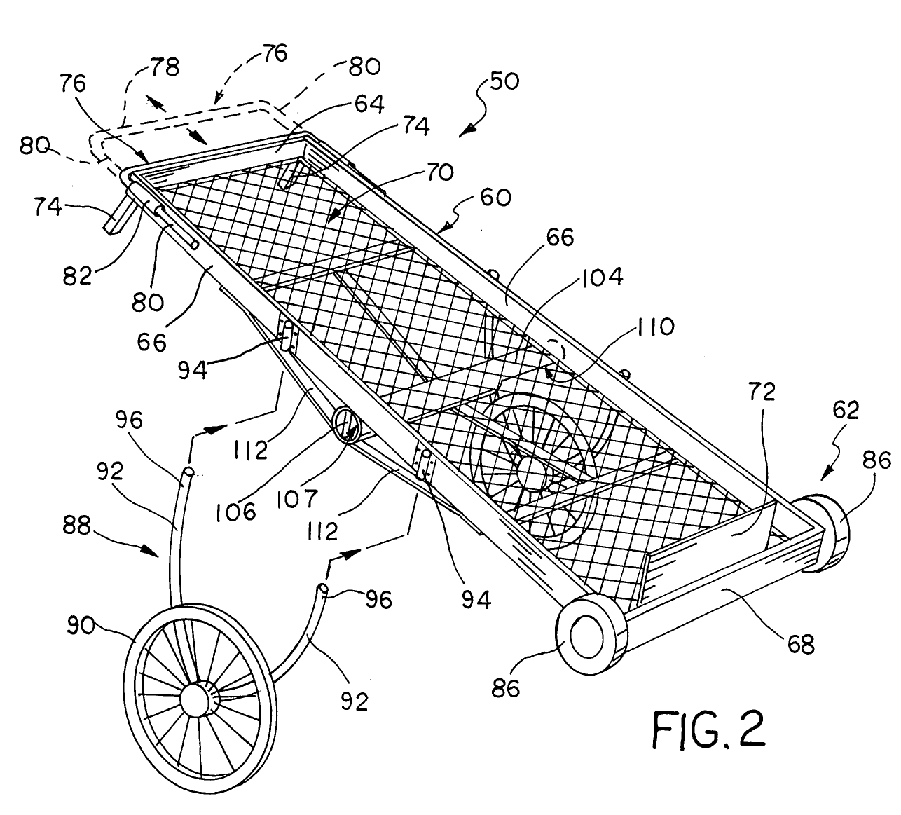

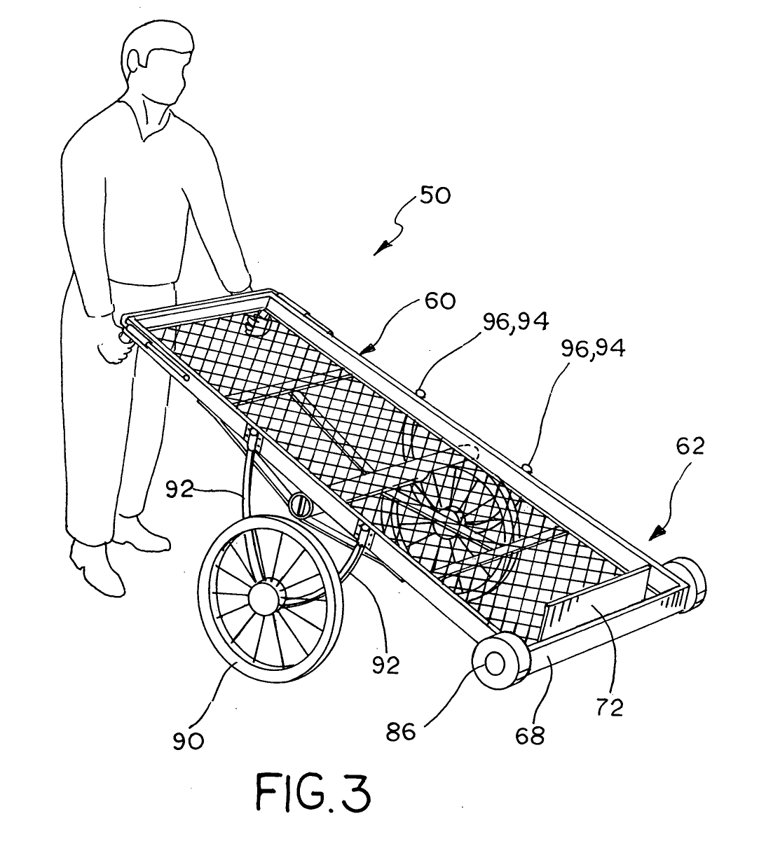

As shown in FIGS. 1-3, the cart 50 has two different, optional handle configurations that can be grasped by a user in order to maneuver and move the cart. The first handle configuration in this example includes a pair of fixed hand grips 74 that project downward and rearward from the frame 60. The hand grips 74 are positioned adjacent upper corners of the frame near the handle rail 64. The second handle configuration in this example includes a U-shaped handle 76 with a transverse handlebar 78 and a pair of longitudinal legs 80. The legs 80 can be fixed to the side rails 66 on the frame or can be slidably coupled to the side rails 66 on the frame 60 as shown. In the disclosed example, the handle 76 can be stowed against or adjacent the handle rail 64 when not in use and can be extended from the handle rail as shown in FIG. 2 to an in use position. The handle 76 can also be positionally adjustable relative to the handle rail 64. In that regard, a slide tube 82 is positioned on each of the side rails 66 and the legs 80 are telescopically fitted in the tubes. Though not shown, a securing mechanism can be provided to secure the handle 76 either in the stowed position of FIG. 1 or in a selected extended position for use as represented in FIG. 2. The frame, handles, rails, and platform can be arranged and positioned relative to one another in ways that vary from the disclosed examples. The geometry of the various frame elements can vary, as can the location, number, size, and orientation of the elements. The handle end in this example provides several different gripping options, but these can also vary.

The U-shaped handle 76 can alternatively be angled so that, when extended from the brackets or tubes 82, the handle extends downward in the direction of the hand grips 74. The handle can act as a stand and rest on the ground. The handle can then hold the cart 50 level with the ground while also resting on either the wheels 86 or the wheels 90. This configuration is not shown herein, but the cart is shown in a level orientation in FIG. 5. In another example, the length of the hand grips 74 can be long enough to perform the same function. This feature could help one in loading and unloading the cart 50. Keeping the cart 50 level while resting on the ground can keep items from falling of the platform 70, while the cart is loaded and until such items are secured to the platform, if needed.

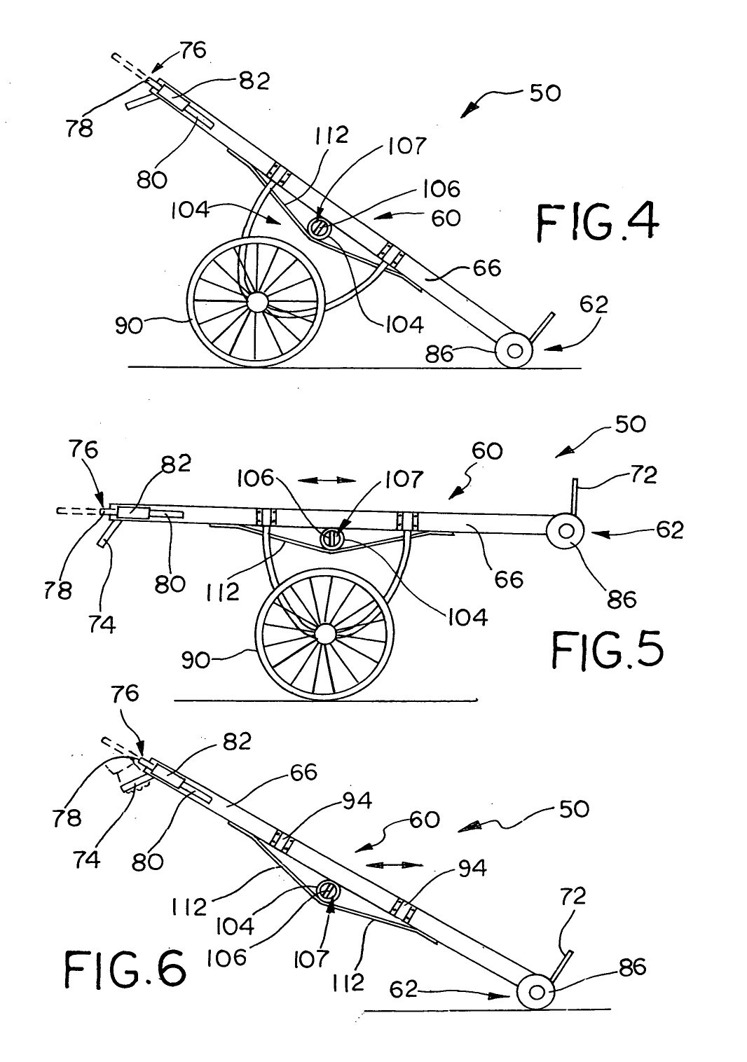

In this example, the base 62 of the cart 50 is carried on the foot rail 68. The base 62 is configured and positioned or located so as to rest on the ground or support surface during normal use of the cart. The base 62 includes a pair of wheels 86, one each rotatably mounted on an opposite side of the frame 60. The cart 50 in this example also can include an optional, removable base 88 as depicted in FIGS. 2-5. The optional or alternate base 88 in this example includes a pair of larger diameter wheels 90 carried on U-shaped legs 92. The legs 92 can be detachable the or removably secured to connectors 94 carried on the side rails 66 of the frame 60 and positioned to locate the wheels 90 near a center of the cart. When detached, the cart 50 can be maneuvered on the wheels 86 of the base 62, as shown in FIG. 6 with a user grasping the handles or handle grips 74. When attached, upper ends 96 of the legs 92 are secured to the connectors 94 so that the wheels are spaced well below the frame 60. When utilizing the base 88, the cart 50 will rest on the larger diameter wheels 90 and the cart may be manipulated in a different manner than one maneuvered on the wheels 86.

As will be evident to those having ordinary skill in the art, the cart 50 can be provided with either the base 62, the alternate or optional base 88, or both within the spirit and scope of the present invention. In addition, though not intended in this example, it possible that the base 62 can be configured so that the wheels 86 are readily removable from the cart 50, if desired. Further, the alternate or optional base 88 noted above can be connected to the cart 50 in a manner not intended for detachment or removal of the wheels 90. Other base configurations and constructions are also possible. In one example, the base or bases may not employ wheels but instead may include skids, rollers, skis, or the like that are coupled to one end of the frame allowing the cart 50 to be maneuvered without being fully lifted off the ground. In other examples, the cart 50 may be provided with only one wheel, more than two wheels, or other wheel configurations different from the examples shown and described herein.

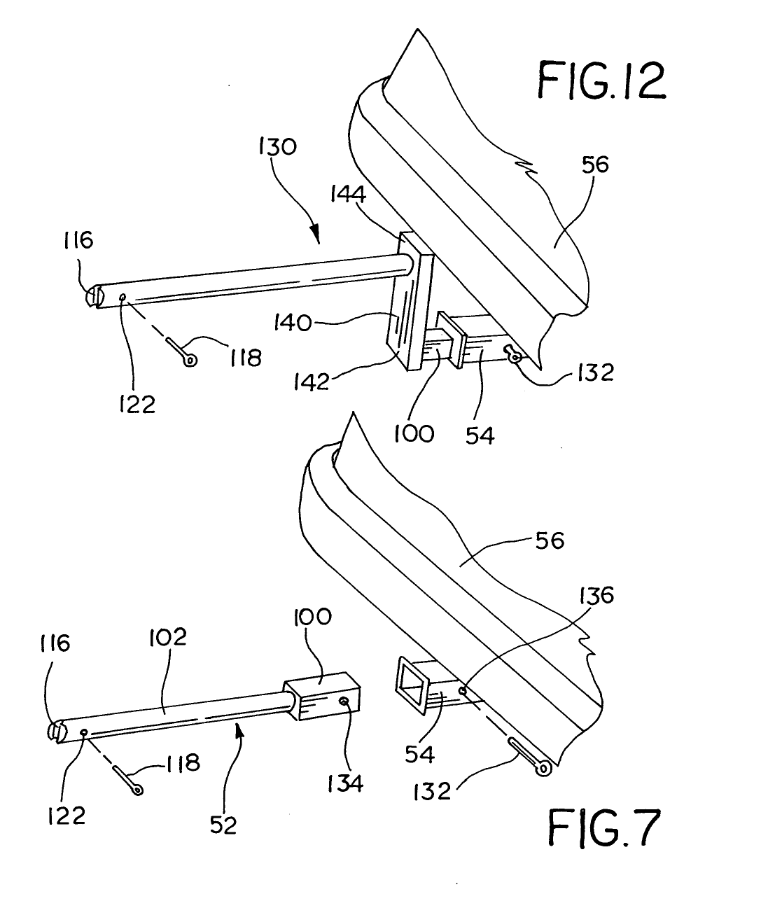

As shown in FIGS. 1 and 7, the vehicle 56 employs a hitch receiver 54 that is an ordinary or conventional rectangular tube mounted under the vehicle 56 an exposed near the vehicles bumper. In order to mount the cart 50 to the vehicle 56, the hitch adapter 52 is configured to be connected to the hitch receiver 54. The hitch adapter 52 is a trailer hitch accessory that can replace other types of hitches and hitch accessories that are also configured to mount to the hitch receiver 54 on the vehicle 56 as is known in the art. The disclosed hitch adapter 52 thus includes a rectangular fitting 100 that slidably fits within the hitch receiver 54. A coupler 102 or tow bar projects from one end of the fitting 100 and is configured to mate with a part of the cart 50. In this example, the coupler 102 is an elongate cylindrical bar projecting directly rearward from the fitting 100. The coupler 102 can be a solid cylinder as shown, or can be a tube and can be configured from steel or other suitable materials as desired.

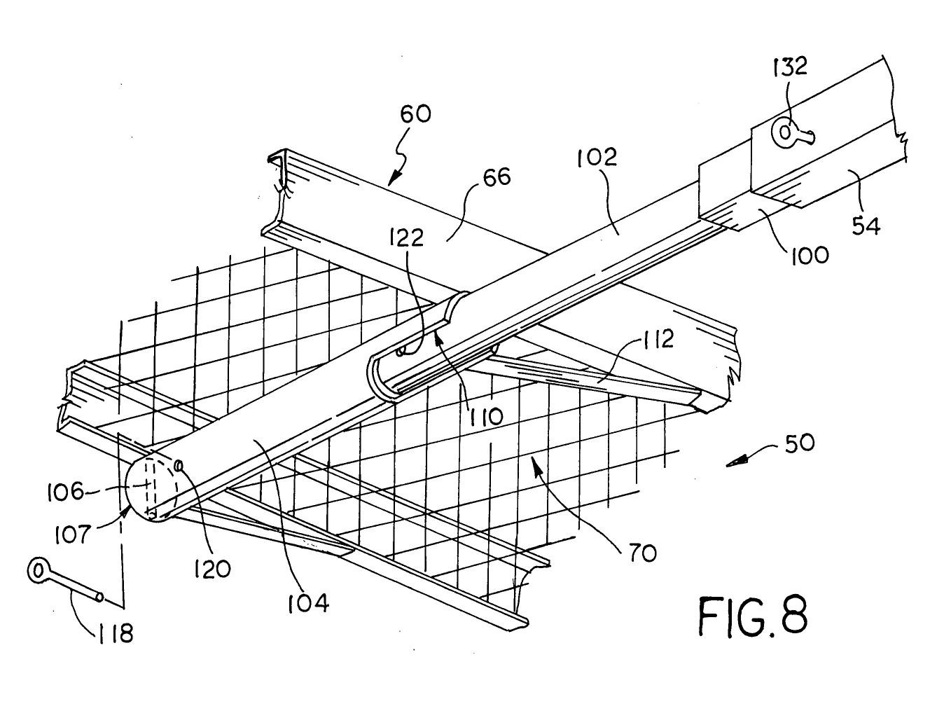

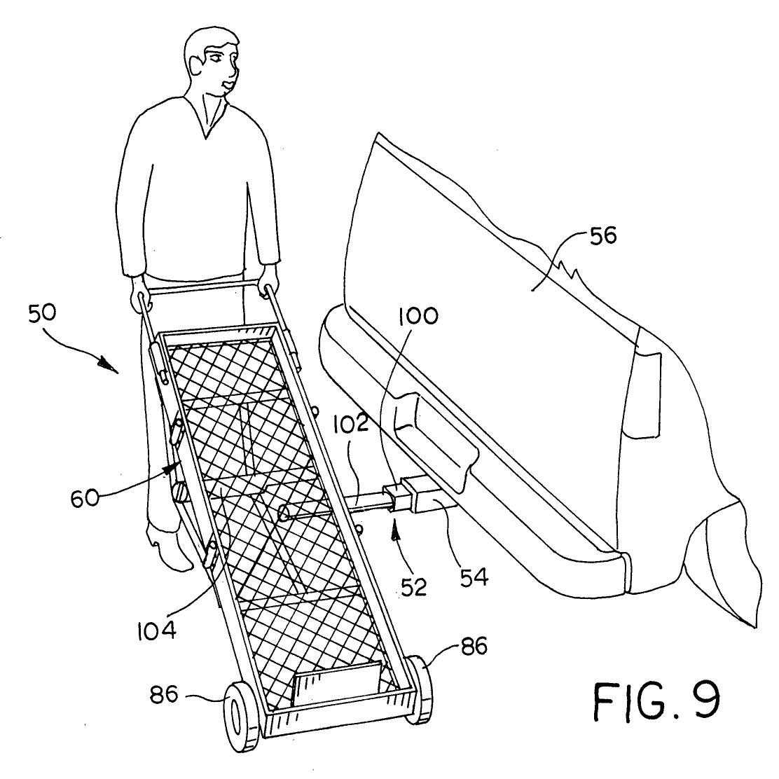

As best illustrated in FIGS. 8 and 9, a hitch mount 104 is positioned beneath the frame 60 on the cart 50. The disclosed hitch mount 104 extends transversely across the frame 60 and is secured to the side rails 66. The hitch mount 104 is positioned generally at the middle of the frame between the handle and foot ends. The hitch mount 104 in this example is an elongate tube sized to slidably receive the cylindrical coupler 102. A stop in 106 is seated across an opening in the exit end 107 of the hitch mount 104. The stop pin 106 can be used to prevent the coupler 102 from passing too far through the hitch mount 104, as a lengthwise positioning device, and/or as a rotational orienting device to properly position the coupler relative to the hitch mount. As depicted in FIG. 8, the opposite end of the hitch mount 104 defines an open entry end 108. The entry end 108 is open to receive the coupler 102. A segment of the tube circumference on the entry end of the hitch mount 104 is cut away. This creates a radial entry 110 into an underside of the hitch mount 104. A radial entry is configured to define a contact or landing zone on the hitch mount 104.

In this example, the hitch mount 104 can be welded or otherwise secured using fasteners to the frame 60. As shown, a plurality of rigid straps 112 or buttresses can be added to the structure of the frame 60 in order to further strengthen the attachment between the hitch mount 104 and the cart 50. As will become evident to those having ordinary skill in the art upon reviewing this disclosure, the configuration and construction of the hitch mount 104 and the coupler 102 can vary within the spirit and scope of the present invention. The embodiments disclosed and described herein are provided merely to illustrate a number of alternative examples and to enlighten those skilled in the art as to the various possible alternatives. The hitch mount tube can be an alternately curved plate or contact surface on the underside of the frame. The tube or contact surface can be provided as multiple segments or as single component as shown. The resting surface or entry can be a separate plate or can be an integral part of one of the components, such as the mounting tube as shown. Positional stops can be provided as part of the frame instead of part of the hitch mount and can also vary from the pin 106 and the mating notches or grooves in the coupler.

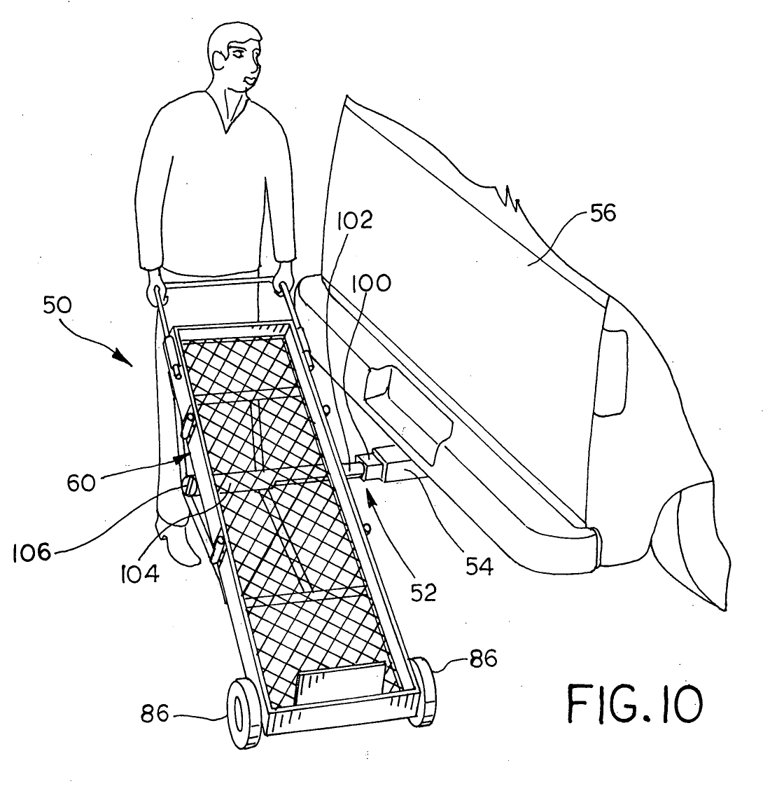

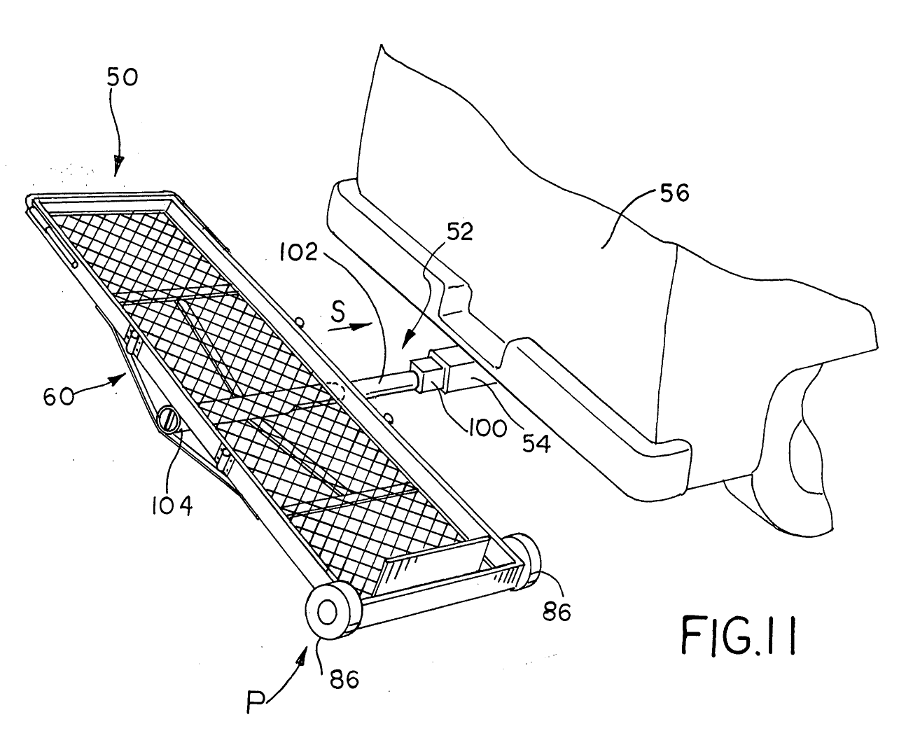

In accordance with the teachings of the present invention, the cart 50 can be easily mounted to the vehicle 56 without having to load, unload, and/or reload objects or articles onto or from the cart 50. With reference to FIGS. 1 and 8-11, a user can maneuver the cart 50 using either one of the optional handle configurations 74 or 76, whether or not the cart is loaded with objects, articles, goods, containers, or the like. The cart can be maneuvered along the ground or a support service utilizing a base of the cart, such as the wheels 86. The user can position the cart 50 so that the hitch mount 54 is positioned adjacent the coupler 102, which has been connected to the vehicle's hit receiver 54. In this example, the user can position the cart 50 behind the vehicle 56 with the hitch mount 104 in line with the coupler 102 and with the hitch mount entry 110 positioned directly over the free end of the coupler as represented in FIG. 9. The user can then drop or lower the cart 50 onto the coupler 102 so that the end of the coupler passes into the landing zone or entry 110 and seats against the hitch mount 104, i.e. the tube interior surface 114 as shown in FIG. 10. The user can then simply push downward on the handle end of the cart 50. This will pivot or rotate the cart 50 on the coupler 102 about the hitch mount 104 in the direction of the arrow P. The base or wheels 86 will then be raised off of the support service as represented in FIG. 11. The user can then simply slide the hitch mount 104 and the cart 50 further onto the coupler 102 in the direction of the arrow S to a position represented in FIG. 1. The reverse operation can be utilized to remove or detach the cart 50 from the hitch adapter 52 in this example.

If the alternate base 88 and wheels 90 are utilized, either the base 88 should be removed from the cart 50 prior to mounting the cart onto the vehicle, or the rotation axis of the wheels 90 and the location of the hitch mount 104 must be offset in order to lift the wheels off of the ground when mounted. In the disclosed example, the hitch mount 104 would need to be closer to the handle end of the frame 60 in comparison to the location of the wheel rotation axis.

As shown in FIG. 7, the tip of the coupler 102 can include a vertical slot or notch 116 that aligns with a stop pin 106. These two components can be oriented so that, when aligned with one another, the cart 50 is level on the coupler 102. A securing mechanism can then be utilized to secure the cart 50 mounted to the hitch adapter 52. In one example, a conventional cotter pin 118 can be received in holes 120 and 122 formed through both of the hitch mount 104 and coupler 102, respectively. The holes 120 and 122 will align with one another when the cart 50 is level. Other securing mechanisms are within the spirit and scope of the present invention. The invention is not intended to be limited in any way to a particular type of securing mechanism to hold the cart 50 mounted to the adapter 52.

With reference to FIGS. 7 and 12, an alternate example of a hitch adapter 130 is shown in comparison to the earlier described hitch adapter 52. In this example, the hitch adapter 130 includes an identical fitting 100 that is configured to connect to the vehicle's hitch receiver 54. In either embodiment, a similar conventional securing mechanism can be used to secure the hitch adapter 130 (or the adapter 52) to the hitch receiver 54. As shown, a cotter pin 132 can be received through openings 134 and 136 in the respective fitting 100 and receiver 54.

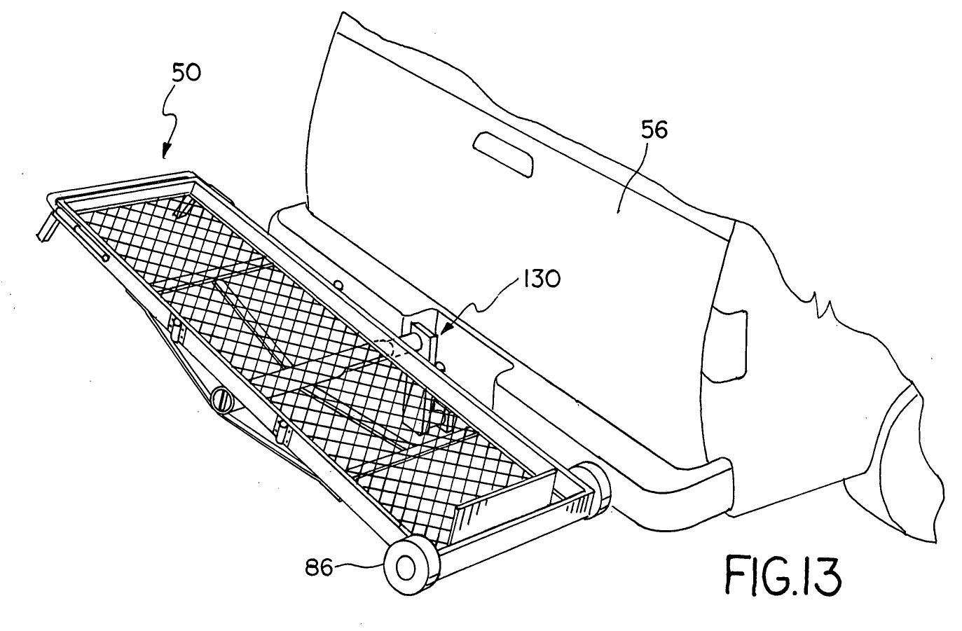

The hitch adapter 130 in this example includes a vertical stanchion 140 connected at one end 142 to a free end of the fitting 100. A coupler 102, which in this example is identical to the earlier described coupler of the adapter 52, projects from an upper end 144 of the stanchion 140 in a direction opposite to fitting 100. FIG. 13 shows the cart 50 mounted to the hitch adapter 130. In this example, the cart 50 will be mounted further above the ground in comparison to the mounting arrangement shown in FIG. 1. The adapter 130 can be utilized as part of a modular system provided with the cart 50. If the base 88 with the larger wheels 90 are mounted to the cart 50, the hitch adapter 130 may be suitable. If only the base 62 and smaller wheels 86 are mounted to the cart 50, the lower height hitch adapter 52 may be suitable. The hitch adapter 130 and the cart 50 can be mounted to the vehicle 56 as represented in FIG. 13 as previously described with respect to the hitch adapter 52.

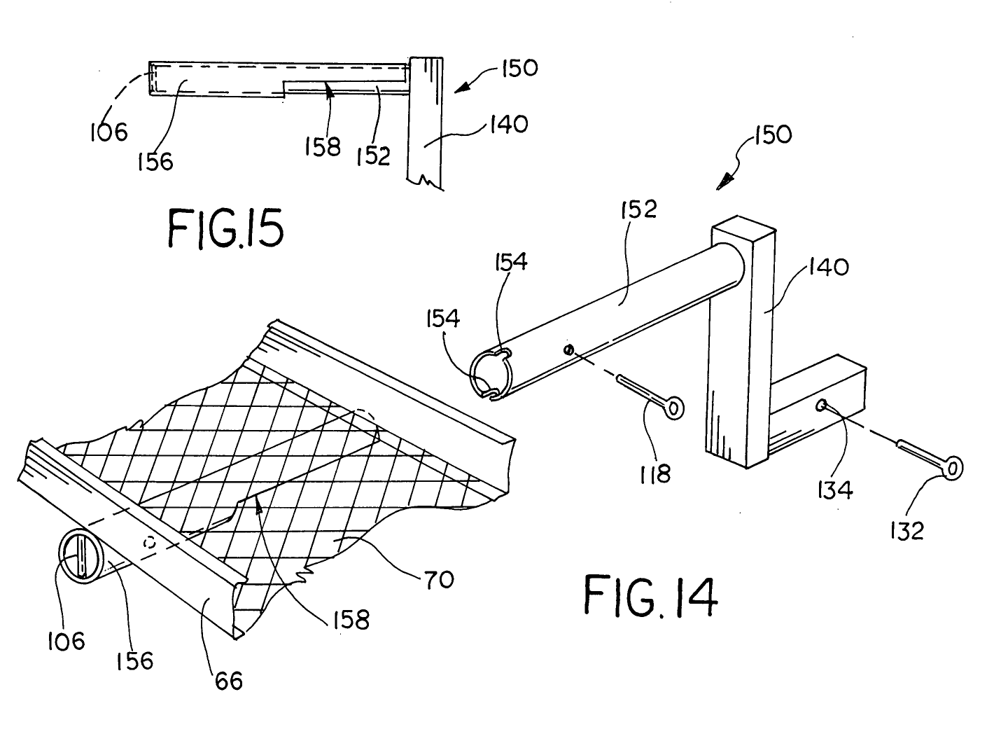

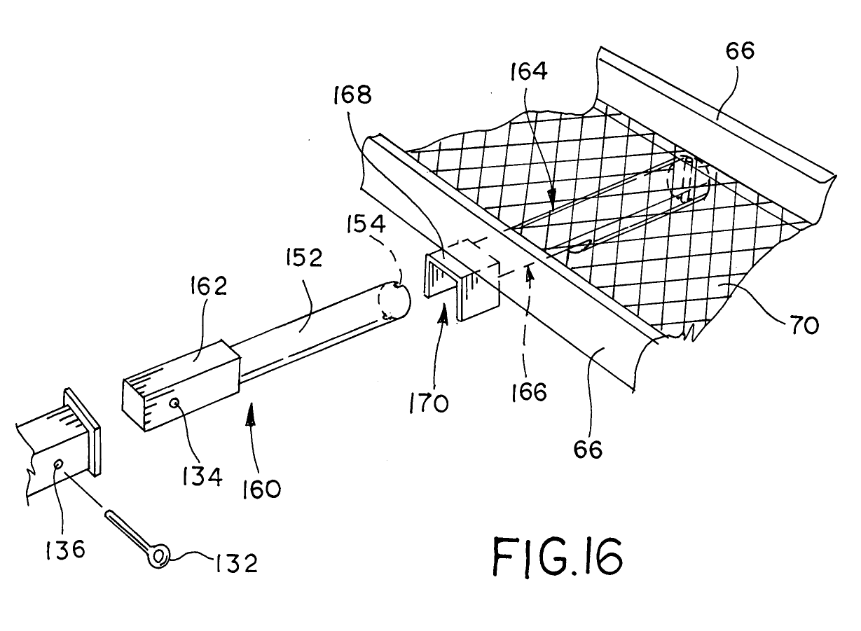

FIGS. 14 and 15 show another example of a hitch adapter 150 constructed in accordance with the teachings of the present invention. The hitch adapter 150 includes the fitting 100 and the stanchion 140. In this example, the hitch adapter 150 has a coupler 152 that is a hollow tube and that extends from the upper end 144 of the stanchion 140. A pair of vertically aligned notches 154 is formed in the edge of the tube at the free end of the coupler 152. The cart 50 in this example employs a modified hitch mount 156. The only difference between the hitch mount 156 and the hitch mount 104 is that the entry 158 extends about one half the length of the tube, which is much longer than the entry 110 on the earlier described hitch mount. The longer entry 158 creates a larger landing zone for connecting the hitch mount to the coupler 152. This may make it easier for a user to mount the cart 50 to the hitch adapter 150, especially when the cart is fully loaded with heavy goods. A stop pin 106 is positioned at the exit end 107 of the hitch mount 156 that will align with the notches 154 when the cart 50 is level and slid fully onto the coupler 152.

FIG. 16 shows another example of a hitch adapter 160 constructed in accordance with the teachings of the present invention. The hitch adapter 160 includes an alternate mechanism for leveling the cart 50 when mounted to the adapter. The hitch adapter 160 includes fitting 162 for mounting to the vehicle's hitch receiver 54. The fitting 162 in this example is longer than the earlier described fittings 100 so that a portion of the rectangular tube extends outward from the hitch receiver 54 when secured to the vehicle. The hitch adapter 160 also includes a coupler 102 identical to the earlier described hitch adapter 52. The cart 50 in this example also includes an alternate hitch mount 164 replacing the earlier described hitch mounts 104 and 156. The hitch mount 164 in this example is again a hollow cylindrical tube with a lengthy entry 166 and a stop pin 106 at the exit end 107. A rectangular box 168 with an open bottom 170 is positioned on the entry end of the hitch mount 164 so that the open bottom 170 coincides with the entry 166 on the tube. When the cart 50 is mounted to the hitch adapter 160 in this example, the cart can be rotated level and then pushed fully onto the coupler 102. The rectangular box 168 will slide onto the exposed portion of the fitting 162. The making rectangular configuration of the two components will rotationally lock the hitch mount 164 and thus the cart 50 relative to the hitch adapter 160 keeping the cart level on the adapter.

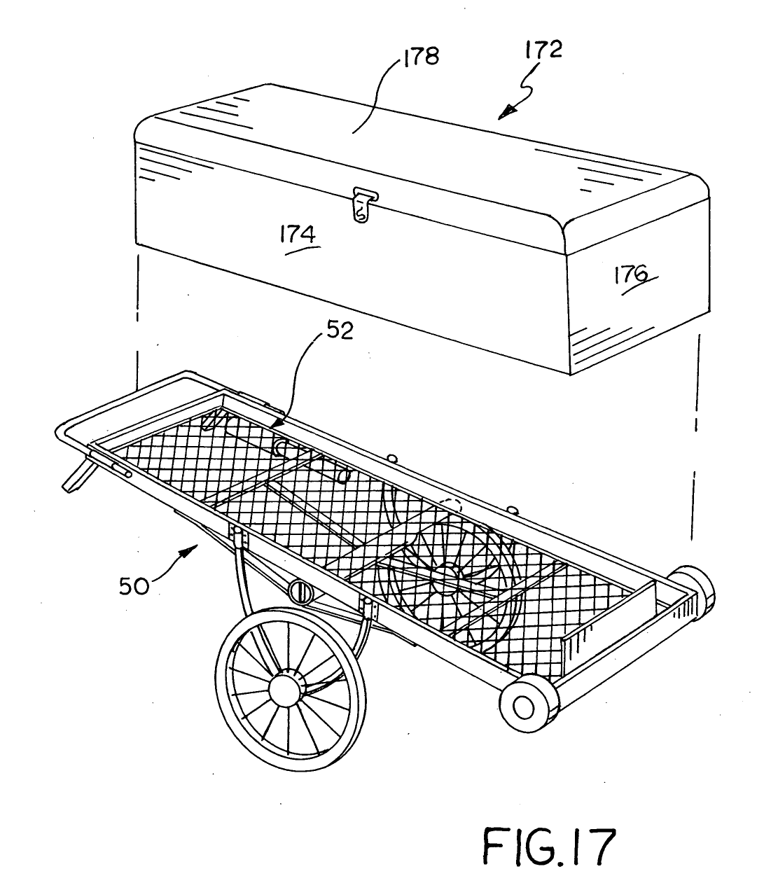

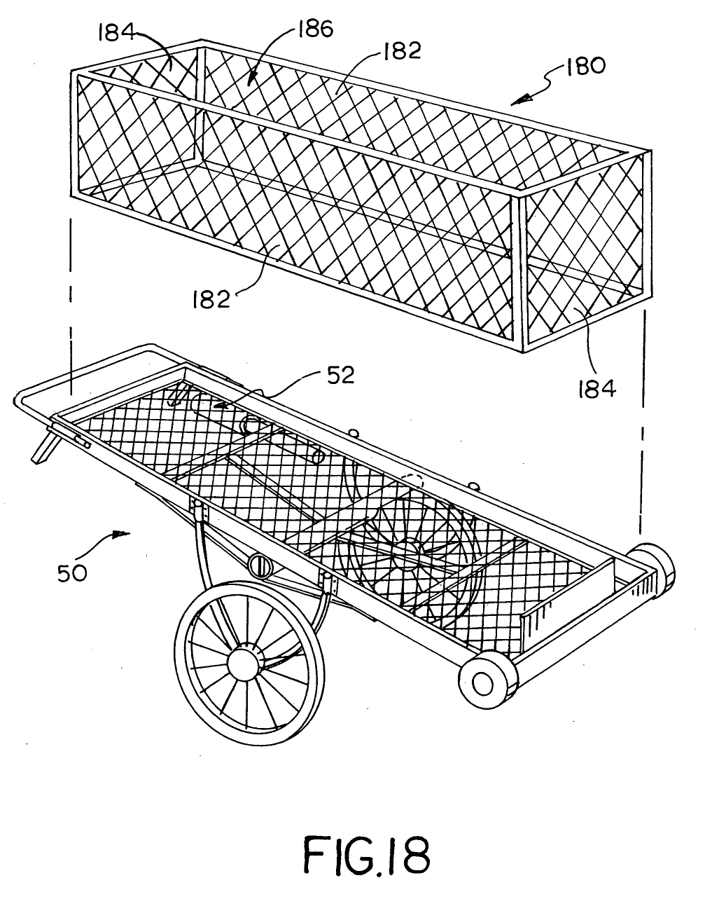

FIGS. 17 and 18 show two alternate examples of carts with containers constructed in accordance with the teachings of the present invention. FIG. 17 shows the cart 50 with a large storage box 172 fitted to the platform 70. The storage box 172 includes a pair of side walls 174 and a pair of end walls 176 arranged to create a rectangular box configuration. The storage box 172 also has a lid 178 that can be opened or closed over a top opening of the box. The storage box 172 can be fitted with a bottom so that the box can be removed from the cart 50 and used separately as a storage device.

FIG. 18 shows the cart 50 with a rectangular cage 180 fitted to the platform 70. The cage 180 includes a pair of perforate or grid side walls 182 and a pair of perforate or grid end walls 184 arranged to create a rectangular box with an open top 186. Either or both the storage box 172 or the cage 180 can be utilized in conjunction with the cart 50 to store and transport goods without having to additionally secure the goods directly to the platform 70 or frame 60 of the cart 50. In either example, the storage box 172 or the cage 180 can be integrally formed as a part of the cart 50 or other such transport device. Alternatively, the box and the cage can be provided as separate units attachable two and detachable from the platform 70 or frame 60 of the cart. Separate securing means can be provided to physically attach the box and the cage to the cart and can vary within the spirit and scope of the present invention. In addition, the shape, size, structure, and configuration of the storage box 172 and the cage 180 can also vary. Either of the components can be provided with compartments, dividers, removable containers, retainers, straps, and other accessories as desired.

FIGS. 17 and 18 show another optional aspect of the invention. The cart 50 or transport device can be configured so that the hitch adapter, such as the adapter 52 as shown, can be stowed on the cart. In this example, the hitch adapter 52 is mounted to the underside of the cart 50 along an inside of one of the side rails 66 near the handle grip 74. Any suitable clip, clamp, or bracket mechanism can be used to removably attach the hitch mount to the cart. Other hitch mounts as disclosed herein or in accordance with the teachings of the present invention can also be stowed on the cart when not in use.

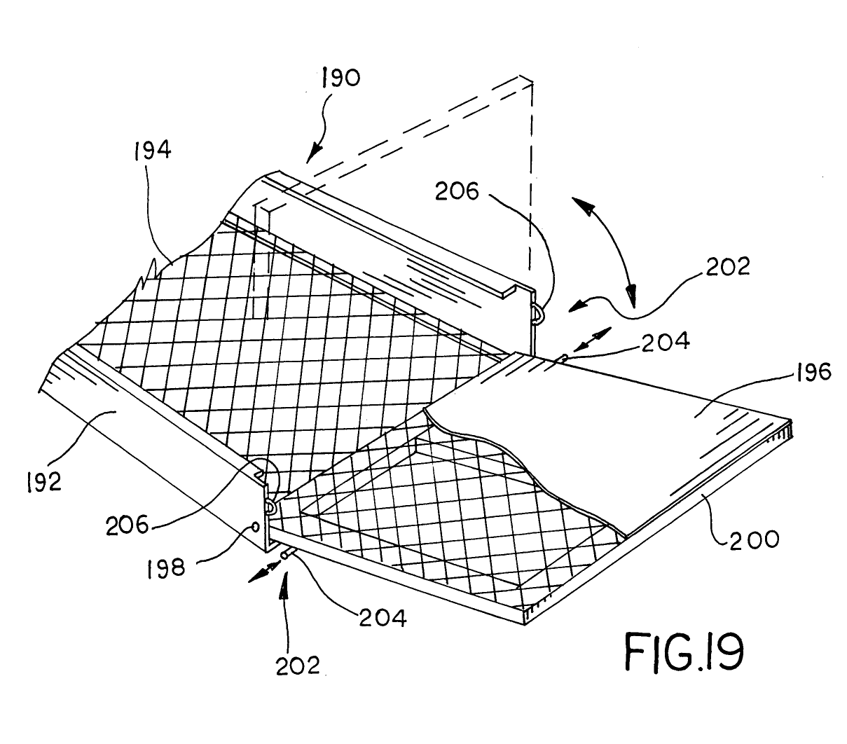

FIG. 19 shows another example of a cart 190 constructed in accordance with the teachings of the present invention. In this example, the cart 190 has a frame with a pair of frame side rails 192 and a platform 194 positioned between the rails. The foot rail 68 and foot plate 72 from the earlier example are replaced by a pivotable ramp 196. The wheels 86 are not show, simply for ease of description, but could be utilized on this cart. The ramped 196 has one end pivotally secured on pivots 198 or an axle to the side rails 192. The ramp 196 can be secured in a closed orientation (shown in phantom) mimicking the earlier described foot plate 72 wherein the ramp is fixed in a position normal or perpendicular to the platform 194. The ramped 196 can also be pivoted to an open position whereby a free end 200 of the ramp can hit the ground or support surface. In the open orientation, articles or goods with wheels can be rolled up onto the ramp 196 and then onto the platform 194. Such articles can includes, lawn mowers, compressors, bicycles, or the like. The ramp can be utilized in this manner whether the cart 190 is partly mounted to a vehicle hitch or completely separate from a vehicle. Latches 202 can be positioned on either side of the ramp 196 and configured to secure the ramp in the closed position relative to the cart 190. The latch mechanisms 202 can be any suitable latch type, such as one having a latch 204 positioned on each side of the ramp 196 and a latch receiver 206 positioned on the end of each of the side rails 192 on the cart 190.

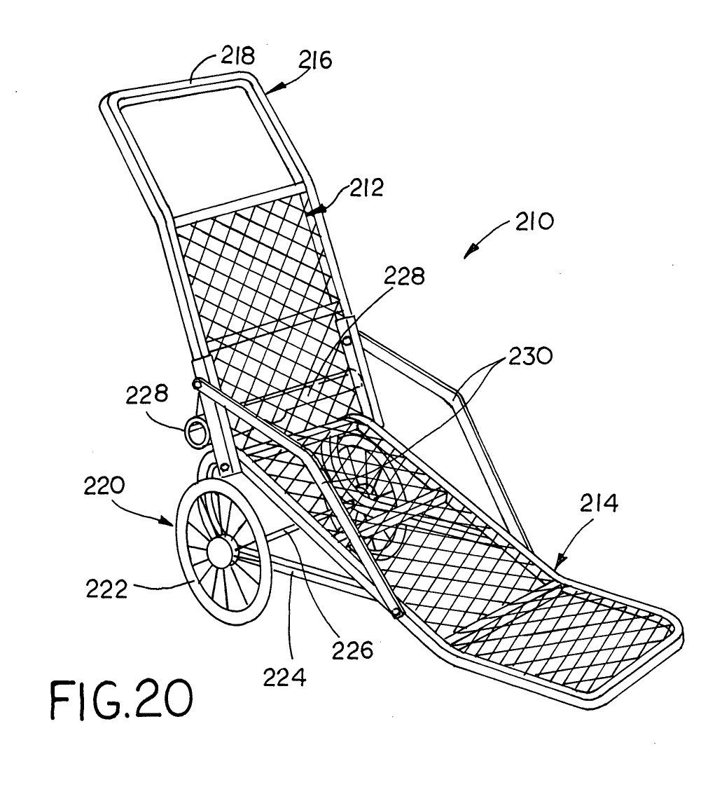

FIGS. 20 and 21 show another example of a cart 210 constructed in accordance with the teachings of the present invention. In this example, the cart 210 has a frame structure configured to form a platform with two sections 212 and 214. The platforms 212 and 214 are oriented at an angle relative to each other. In this example, the upper platform section 212 includes a fixed handle 216 with a transverse handlebar 218. The cart 210 also has a base 220 with a pair of large diameter wheels 222 fixed to wheel brackets 224 under the platform sections. In this example, the wheel brackets 224 are not intended to be removable from the cart, although they certainly could be removable. As shown in this example, an axle 226 of the wheels 222 is supported by the brackets and positioned further from the handle 216 than a hitch mount 228, which is secured to the back side of the upper section 212 on the cart. Thus, the hitch mount 228 and the axle 226 are longitudinally offset relative to one another on the cart 210. A pair of frame connectors 230 secure the two frame or platform sections 212 and 214 at a particular angle relative to one another. In an alternate example, the platform or frame sections 212 and 214 can be pivotable relative to one another and the connectors 230 can be adjustable in order to secure the two platform sections at a selected one of a plurality of optional angular orientations. The disclosed cart 210 is representative of the many variations that may be made to the transport devices or carts disclosed and described herein.

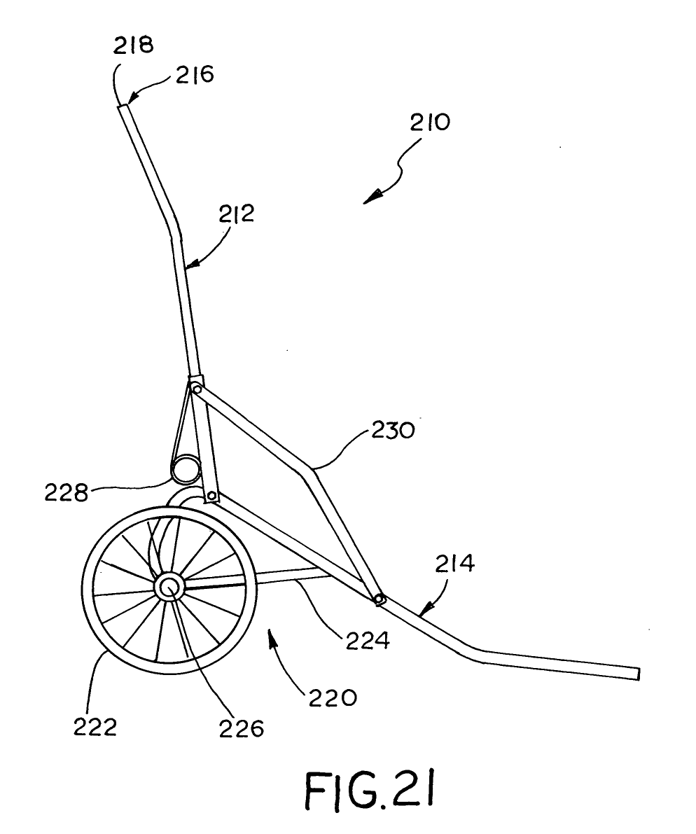

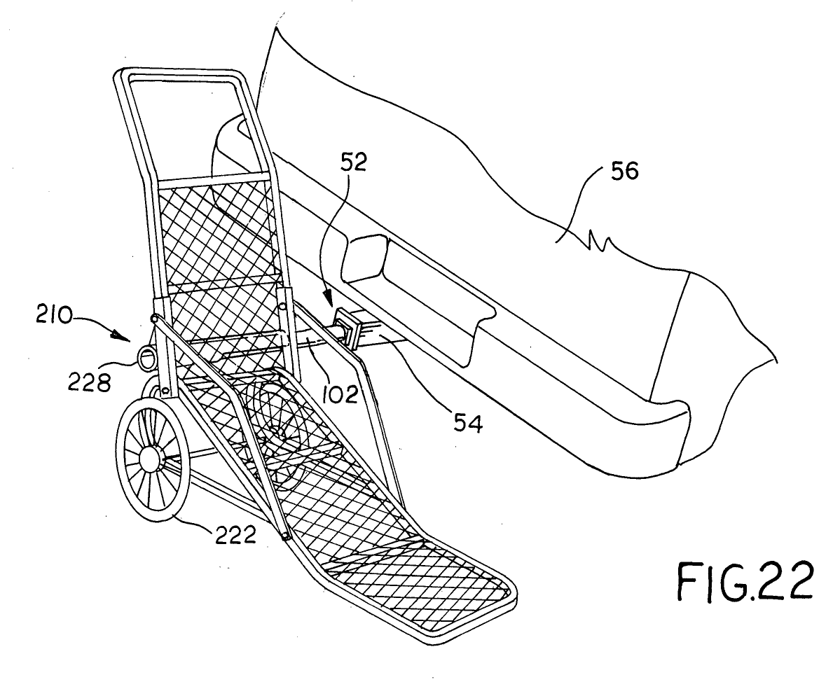

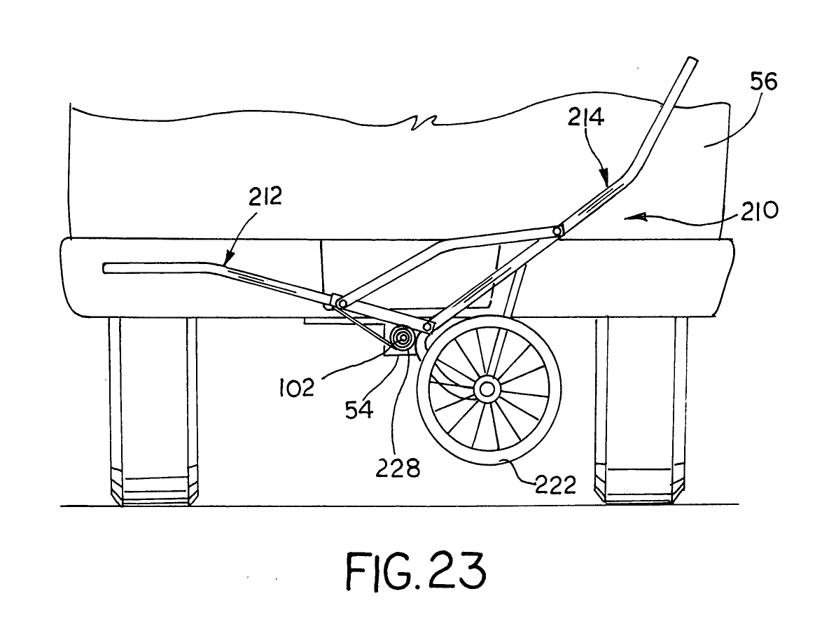

FIGS. 22 and 23 show the cart 210 as it is being mounted to a vehicle 56 and after being mounted to the vehicle, respectively. The cart 210 can be mounted in the same manner as described above with respect to the cart 50. When mounted, the longitudinal positional offset of the hitch mount 228 and the wheel axle 226 allows the large diameter wheels to be tipped up off the ground when mounted. The disclosed cart 210 can be utilized to transport killed game or other large, heavy, oddly shaped objects from the place of acquisition to the vehicle, and then to with the vehicle without having to unload the objects from the cart. As with the base 88 in the prior example, the base 220 in this example can also be configured to be removable from the cart frame. The wheels 222, the brackets 224, or both can be detachable from the cart, if desired. Alternatively, the brackets can be configured to be pivotable up and under the cart frame.

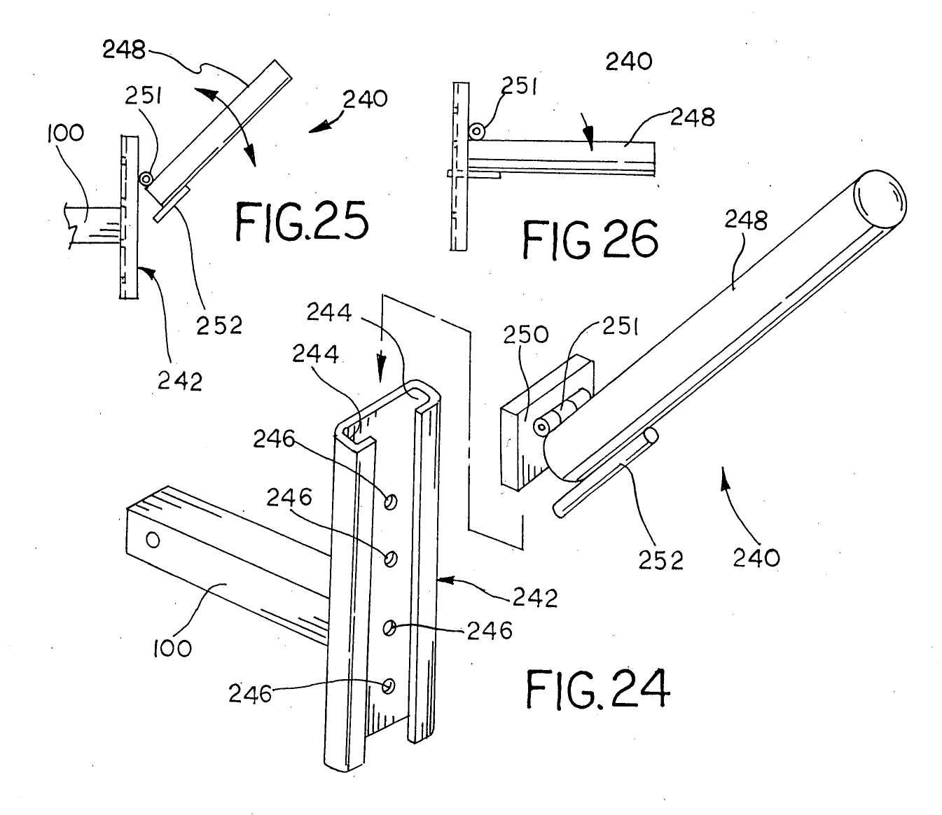

FIGS. 24-26 show another alternative example of a height adjustable hitch adapter 240 constructed in accordance with the teachings of the present invention. In this example, the hitch adapter includes a fitting 100 sized and shaped to connect with the hitch receiver 54 on the vehicle. A vertical stanchion 242 is a fixed to the free end of the fitting 100. The stanchion 242 is configured as an open C-channel defining a vertically oriented track 244 on each side of the stanchion. A plurality of openings 246 are formed through a flat portion of the stanchion 242 between the tracks 244. The hitch adapter 240 has a removable coupler 248 in the form of a solid cylindrical tube. A slider plate 250 is secured via a hinge 251 to one end of the coupler 248. A slider plate 250 is oriented and sized so as to fit within the tracks 244 and be slidable vertically along the stanchion 242. A rod or gudgeon 252 is a fixed to an underside of the coupler 248 with a free portion projecting beyond and beneath the slider plate 250.

As shown in FIG. 24, the slider plate 250 can be slid into the channels 244 on the stanchion 242. As shown in FIG. 25, the coupler 248 can be pivoted upward to an angle not parallel with the stanchion it can be slid vertically along the stanchion to position the coupler at a desired height. The coupler 248 can then be pivoted downward as shown in FIG. 26 to seat a rod or gudgeon 252 in the selected one of the openings 246. If desired, a securing mechanism can be provided on a free tip of the rod or gudgeon in order to securely retain the coupler 248 and the selected position. In one example, the tip of the rod can be threaded and a nut can be threaded onto the rod exposed through the back side of the stanchion.

As will be evident to those having ordinary skill in the art upon reading this disclosure, other height adjustment arrangements and mechanisms can be utilized. The various other hitch adapters disclosed and described herein can be height adjustable relative to the hitch receiver 54 on a vehicle. The hitch adapters can be height adjustable in order to accommodate carts having different sized wheels as discussed above or to accommodate different carts as needed. The hitch adapters can also be height adjustable in order to accommodate different vehicles with hitch receivers located at different heights. In one example, a user may wish to have at least 10 inches of ground clearance between the ground and any part of the cart and hitch adapter. In other examples, the coupler can have more than one threaded portion or could be secured with alternate mechanisms or may be more rudimentary and design and not employ the pivot hinge. Other alternative mounting arrangements and/or hitch adapter configurations to create height adjustability are possible. For example, the stanchion can alternatively have two slidable components that can height adjust relative to one another.

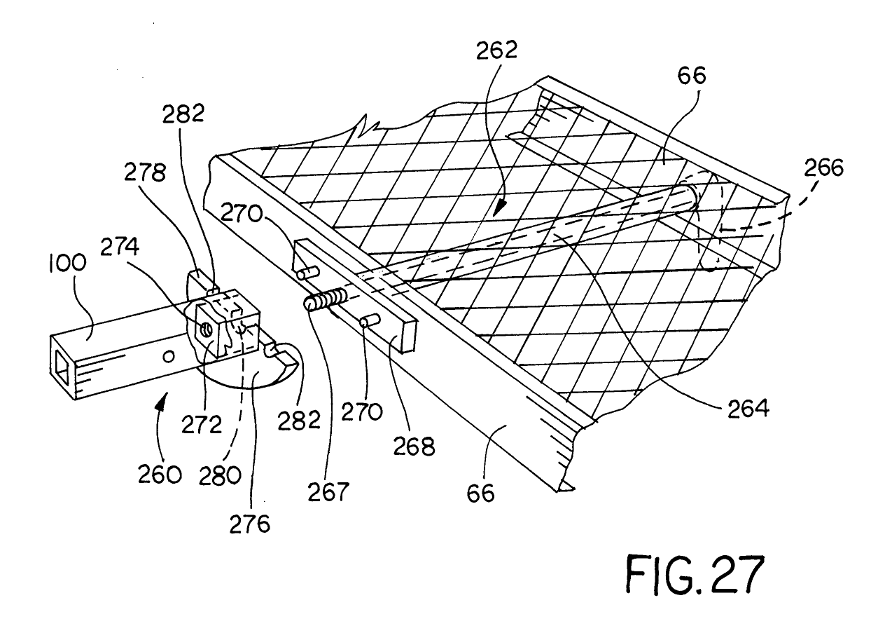

FIG. 27 shows yet another example of an alternate hitch adapter 260 and a cart with an alternate example of a hitch mount 262. In this example, the hitch mount 262 is secured to the side rails 66 on a frame of the cart. The hitch mount 262 has a rotatable shaft 264 extending transversely between the side rails 66. A hand crank 266 is a fixed to one end of the shaft 264 on the outside of one of the side rails 66 and can be used to rotate the shaft. An opposite end 267 of the shaft extends beyond the other side rail side rail to 66 and is threaded. A plate 268 is secured to an outside surface of the side rail 66 and has a pair of guide pins 270 projecting therefrom, along with the threaded portion 267 of the shaft. The guide pins are positioned on opposite sides of the threaded portion 267 of the shaft. In this example, the threaded portion 267 is longer than the guide pins 270 and thus projects further outward from the side rail 66.

The hitch adapter 260 again includes a hitch receiver fitting 100 as previously described. The coupler includes a threaded block 272 positioned within the open free end of the fitting 100 and a threaded orifice 274 therein. The coupler also has a semicircular support plate 276 positioned on the end of the fitting 100 and with a generally flat top exposed edge 278. A center notch 280 is formed in the top edge 278 and is concentrically aligned with the threaded orifice 274. A pair of flanking notches 282 is also formed in the top edge of the support plate 276. The notches 282 are spaced on opposite sides from the center notch 280 and are positioned outward beyond the width of the fitting 100.

In this example, the cart can be rolled up to the hitch adapter 260 and the threaded end 267 of the shaft 264 can be lowered onto the center notch of the support plate 276. The end 267 can then be pushed inward to the orifice 274 as the hand crank 266 is turned to begin screwing the shaft 264 into the block 272 on the hitch adapter 260. As the heads of the guide pins 270 reach the support plate 276, the cart can be pivoted to a level position and the crank 266 can be further turned until the guide pins 270 seat in the respective flanking notches 282. The shaft 264 can then be fully screwed into the block 272.

In one example, the crank 266 can be turned until the face of the support plate 276 abuts the face of the rail plate 268. In such an example, the guide pins 270 and the support plate 276 will assist in holding the cart level while mounted to the hitch adapter 260. In an alternate example, the plates 276 and 268 can be configured so that the top edge 278 of the support plate seats under a bottom edge of the side rail plate when the cart is screwed onto the hitch adapter. In such an example, the crank 266 can be turned until the face of the support plate bears against the face of the side rail 66. The abutting surfaces of the two plates 276 and 268 will then assist in retaining the cart at a level orientation while mounted to the vehicle. The reverse operation can be utilized to remove or detach the cart from the hitch adapter 260 in this example.

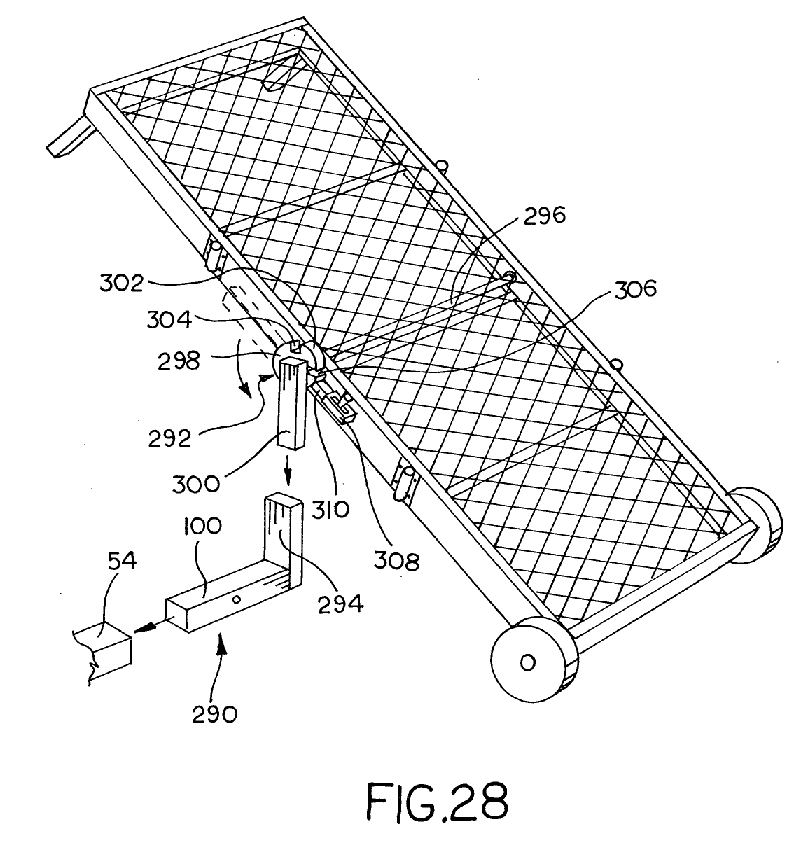

FIGS. 28-30 show yet another example of a hitch adapter 290 and a hitch mount 292 constructed in accordance with the teachings of the present invention. In this example, the hitch adapter 290 includes a conventional fitting 100 to be secured to the hitch receiver 54 on the vehicle. The coupler is a vertical rectangular chuck 294 affixed to the free end of the fitting 100 and has an open top end. The hitch mount 292 has a rotatable shaft 296 extending transversely between the side rails 66 of the cart frame 60. A disc 298 is fitted to one end of the shaft 296 and positioned on the outside of one of the side rails 66. A rectangular block 300 is affixed to an outer face of the disc 298 and projects radially beyond an edge 302 of the disc. The block 300 is sized to fit within the rectangular chuck 294. In the disclosed example, a pair of circumferentially spaced apart notches, including a stow notch 304 and a mounting notch 306, is formed in the perimeter edge 302 of the disc. A spring loaded catch device 308 is mounted to the side rail 66 and adjacent the disc 298. The catch device 308 has a catch finger or projection 310 that extends and is biased toward the disc edge 302.

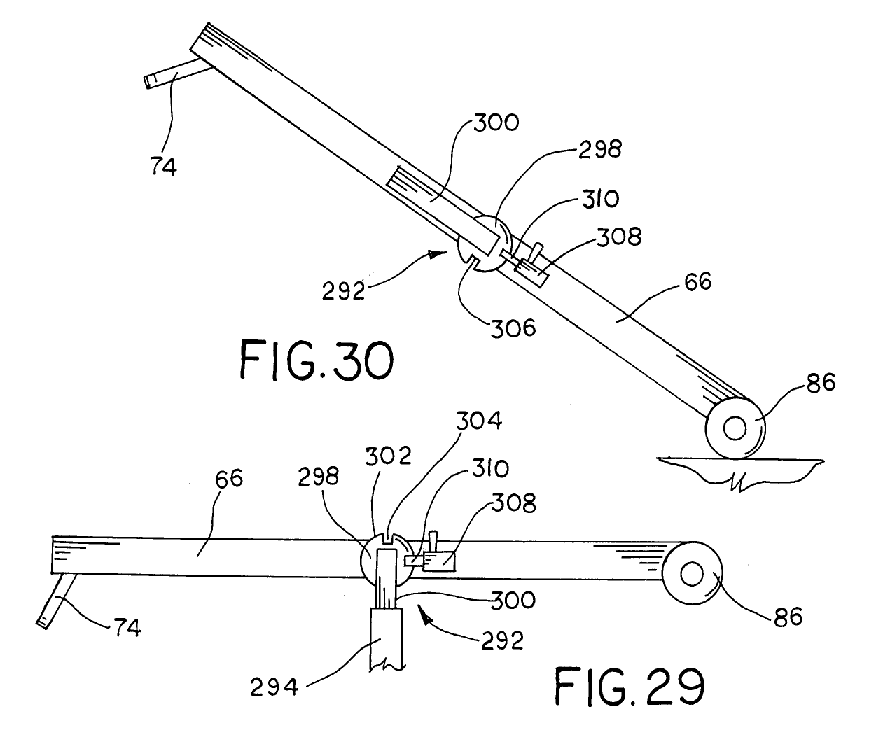

The disc 298 and shaft 296 are free to rotate by gravity and the weight of the block 300 will keep the block extending downward as shown in FIG. 28. The cart can be wheeled up to the hitch adapter 290 with the block 300 positioned directly over the chuck 294. The cart can then be rotated to a level orientation as shown in FIG. 29. Rotating the cart will in turn rotate the disc 298, which is fixed to the block 300, until the mounting notch 306 aligns with the catch projection 310. The catch 308 will fire the projection 310 into the notch 306 to hold the cart in the level orientation while mounted to the hitch mount 290. Though not shown herein, a securing mechanism such as a cotter pin arrangement can be utilized to removably secure the hitch mount 292 to the adapter 290.

The notch 304 can be provided as an option in the edge 302 of the disc 298 in order to stow the block 300 of the hitch mount 292 in alignment with the side rail 66 as shown in FIG. 30. This can prevent the disk and block from freely rotating during normal use of the cart. The construction of the catch device 308 can vary from the examples shown. The device can be a simple spring-loaded dog or tooth pivotally mounted on the side rail or can be a more complex device, as desired.

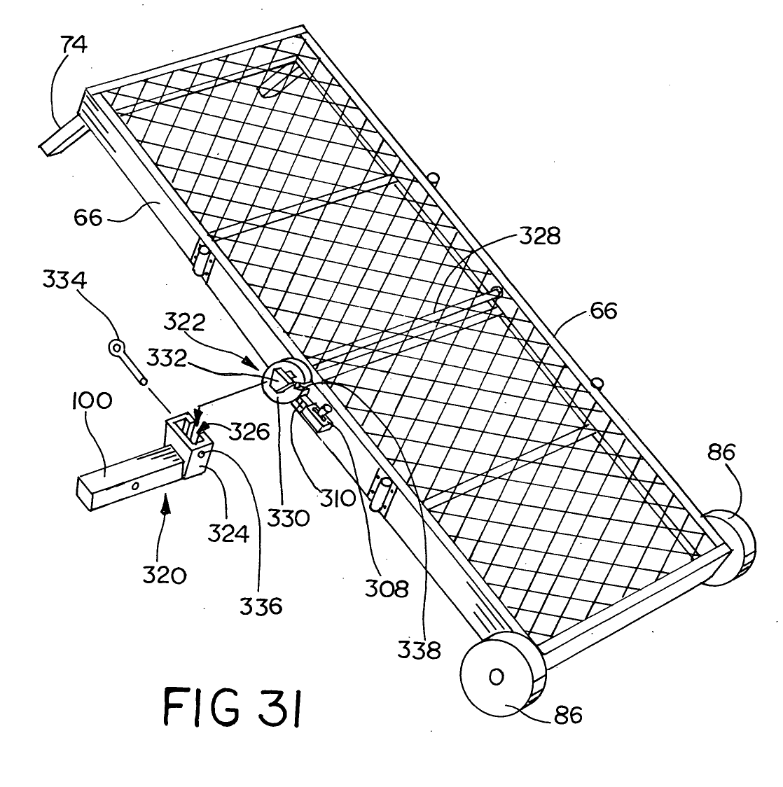

FIGS. 31-33 show yet another example of a hitch adapter 320 and a hitch mount 322 constructed in accordance with the teachings of the present invention. The hitch adapter 320 in this example also includes a conventional fitting 100 for attaching the adapter to the hitch receiver 54 on the vehicle. The coupler of the hitch adapter is a V-shaped, tapered chuck 324 attached to the free end of the fitting 100. The chuck 324 in this example creates a downwardly open channel 326 that narrows between tracks that taper toward one another. The hitch mount 322 again includes a shaft 328 extending transversely between the side rails 66 on the cart. A disc 330 is again secured on the outside of one of the side rails to an end of the shaft 328. In this example, a tapered bit 332 is fixed to and projects from the outer face of the disc 330. The bit 332 has a tapered width configured to match the tapered shape of the channel 326 in the adapter. A catch device 308 with a catch finger or projection 310 is again mounted to the outside surface of the side rail adjacent the disc 330.

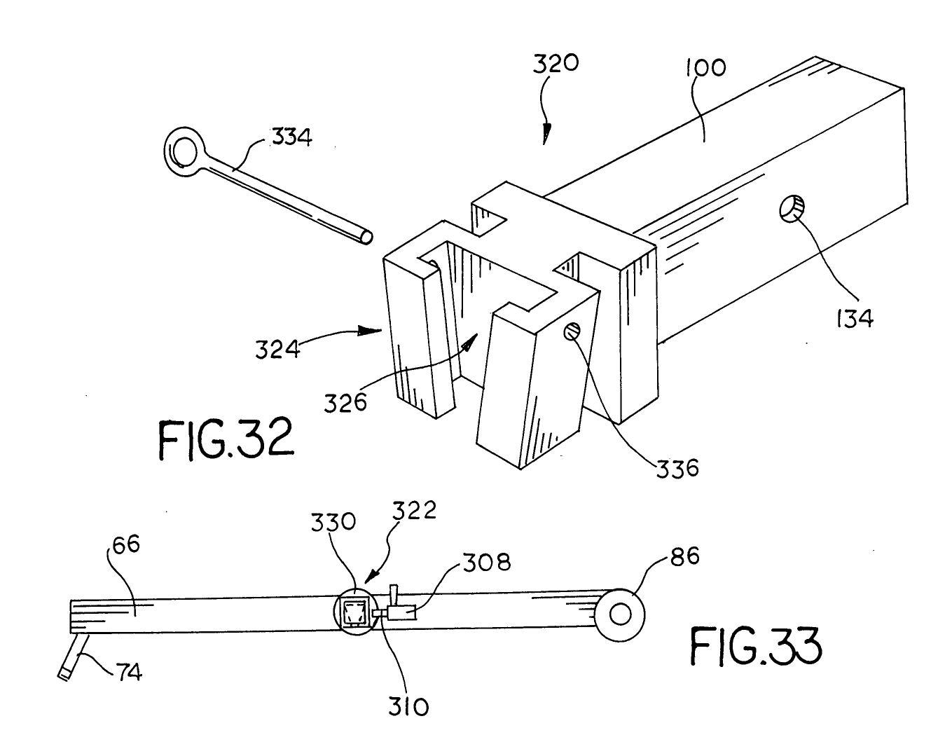

A user can again roll the cart up to the hitch adapter 320 and position the hitch mount 322 directly over the chuck 324. The user can rotate the disc 330 by hand in order to position the narrower end of the bit 332 facing downward into the open top of the chuck 324. The user can then simply lower the cart such that the bit 332 seats in the chuck 324. As shown in FIG. 32, the bit 332 can be secured to the chuck 324 by a cotter pin 334 received through the holes 336 formed laterally through the chuck 324 and, though not shown, through the bit 332. The cart can be pivoted to a level orientation as shown in FIG. 33, at which time the catch device 308 will fire the projection 310 into a mounting notch 338 in an edge of the disc 330. In this example and in the immediately prior example, the catch finger or projection 310 of the catch device 308 can be withdrawn against bias of the spring to release the catch device from the mounting notch 338 or 306. The cart can then be rotated putting the base or wheels on the ground and then the hitch mount 322 can be lifted from the hitch adapter 320 to detach the cart from the vehicle hitch.

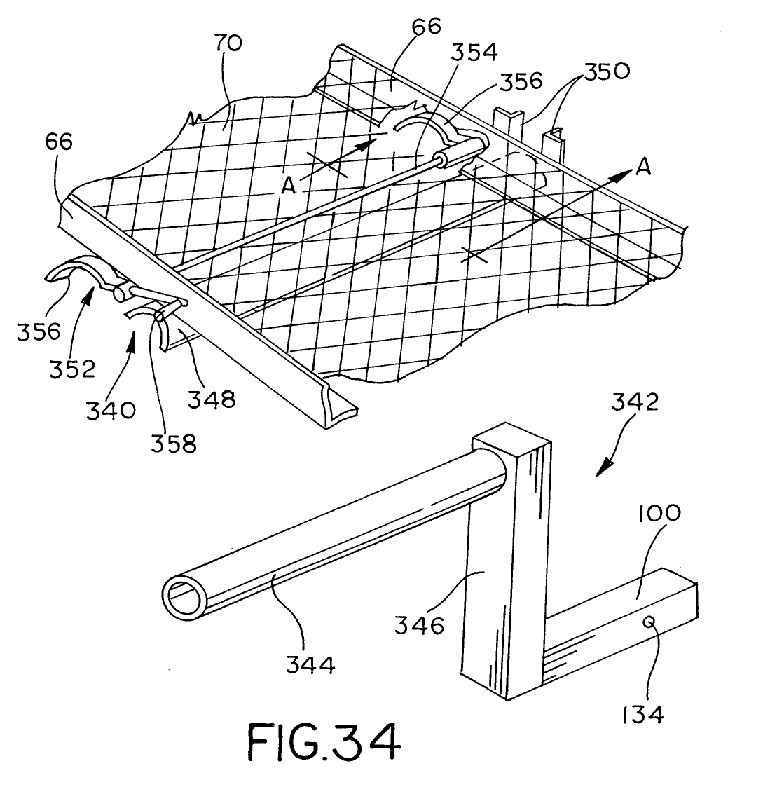

FIGS. 34-36 shows still another alternate example of a hitch mount 340 constructed in accordance with the teachings of the present invention. The hitch mount 340 in this example is configured to attach to a hitch adapter 342 similar to those described above. In this example, the hitch adapter 342 has a coupler 344 in the form of a circular tube or bar. The coupler 344 is carried on the upper end of a stanchion 346, which in turn is attached at its lower end to a hitch fitting 100. The hitch mount 340 in this example has a one-half tube segment 348 that is entirely open along the bottom face. This exposes the interior surface of the tube segment over the length of the hitch mount. The tube segment 348 is again affixed to the side rails 66 of a cart and oriented transversely across the cart frame.

The hitch mount 340 in this example also includes a pair of orientation plates or channels 350. The pair of plates 350 is secured on the outside surface of one of the side rails 66. The plates are spaced and confront one another and are oriented perpendicular to the frame rails 66. The gap between the plates 350 is sized to receive the width of the stanchion 346 therebetween as shown in FIG. 35. When the cart is fully mounted to the hitch adapter 342 and rotated to a level orientation, the cart can be pushed fully onto the hitch adapter so that the stanchion 346 seats between and is captured by the plates 350. The plates will thus retain the cart in the level orientation while mounted to the hitch adapter.

The hitch mount 340 also includes a locking device 352 that will clamp the coupler 344 of the hitch adapter 342 against the tube segment 348 of the hitch mount 340. The locking device 352 has a shaft 354 extending transversely between and pivotally mounted to the frame side rails 66. The shaft 354 is positioned adjacent and parallel to, but spaced from, the tube segment 348. In this example, the locking device 352 has a pair of curved clamps 356 that extend radially from the shaft 354. The clamps 356 are spaced lengthwise from one another along the shaft 354 and are shaped to match the bottom shape of the coupler 344. One end of the shaft 354 includes a hand crank 358, which can be used to open the locking device 352 to the position shown in FIG. 34. In this position, the cart and the tube segment 348 of the hitch mount 340 can be lowered onto the coupler 344. The hand crank 358 can then be turned to close the clamps 356 onto the coupler 344 as shown in FIG. 35. The cart can be positioned and mounted to the hitch adapter 342 in a manner as otherwise previously described and then locked into place by cranking the locking device 352 to close the clamps 356. The cart can be released from the hitch adapter by opening the locking device.

A securing mechanism can be utilized to retain the locking device 352 in the closed position. The securing device can vary in configuration and construction. In one example, though not shown herein, the free ends of the clamps 356 and a mating edge of the tube segment 348 can include latch portions that align with one another when closed and that can then be secured to one another. In another example, the locking device can include a ratcheting mechanism or other detent-type mechanism to automatically secure and retain the locking device 352 in the closed position when closed.

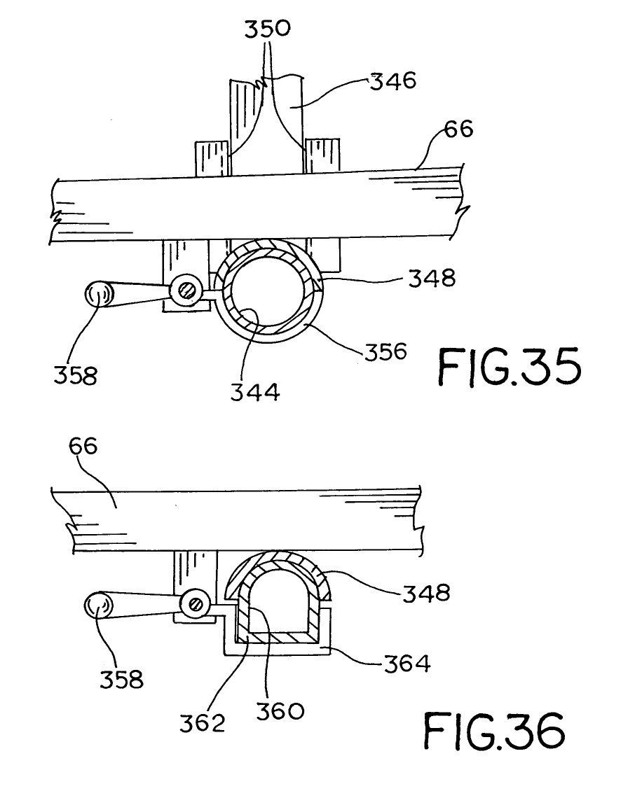

FIG. 36 shows an example similar to that in FIGS. 34 and 35, but wherein the orientation plates 350 are replaced by an alternate anti-rotation scheme. In this example, the hitch adapter has a non-circular tube or coupler 360. The coupler 360 is round on top to mate with the tube segment 348, but square on the bottom 362. The previously described clamps 356 of the locking device are replaced in this example by square-shaped clamps 364 to correspond in shape to the square bottom of the coupler. The square shape of the clamps 364 and bottom 362 of the coupler would prevent the cart from rotating and keep it level once mounted to the hitch adapter.

In many of the examples, the securing mechanisms to retain connections between the handle 76 ad the frame 60, between the hitch receiver and the hitch adapter, between the hitch adapter and the hitch mount, and the like can vary. As will be evident to those having ordinary skill in the art, other or additional attachment methods and devices can certainly be utilized. Spring pins or spring balls can be used to automatically pop into place upon installation or connection. Secondary latches and/or locks can also be utilized, if desired.

The larger diameter, center mounted wheels 90 can be made to detach and then reattach flush against the underside of the support surface for ready transport, if desired. Alternatively, the wheels can just be removable as shown. In another example, the wheels and mounting supports or brackets can be configured to pivot between a stowed position against the underside of the platform and the extended in-use position.

If any sideways movement is required of the cart before being able to tip the cart to a wheels-up orientation, the frame can include on or more rollers or slides optimally placed to permit the frame to slide or glide sideways. In addition, one side of the frame can include one or more hand grips, small U-shaped handles, or the like positioned to assist one in pivoting the cart, once rested on the hitch adapter and/or pushing the cart further onto the hitch mount after being pivoted to a level orientation. As noted above, the cart platform can vary from the examples shown. In the illustrated examples, the cart has a wire mesh platform, which can be used to provide durability and strength and yet limit weight and material cost for the product. The disclosed carts or transport devices can be formed to accommodate a wide variety of uses. The disclosed hitch adapters and hitch mounts can be added to a wide variety of products, other than carts. Such products could then be mounted and towed as described herein. In one example, a compressor with a fixed tank and wheels set could be modified to incorporate a hitch mount and to mount to a hitch adapter as described herein.

The frame and/or platform can take the shape of a vessel, like a wheelbarrow, and be used to transport and tow wood, wood chips, dirt, seed, and the like. In another example, the support surface can be configured to load and tow bicycles, scooters, motorcycles, wheelchairs, and the like. Such a cart-like product could have an extendable support surface, instead of a short ramp. The surface could then be extended and/or tipped downward to load the item and then be tipped back to the towing or horizontal orientation during or after loading. The cart-like product can also be configured to secure the item to the platform or support surface once loaded. In yet another example, a portion of the frame, support surface, or platform, or the entirety of same can be formed to include a covered storage container or enclosure as discussed above. The lid can be lockable and the container can be weatherproof. In still another example, the storage enclosure could be formed so as to create a portable “closet” that can be tipped and towed as described herein. When detached from the vehicle, the portable “closet” can be rolled away from the vehicle to be used as an upright “closet” in one's home, vacation destination, hotel room, and the like. Such an enclosure can include a clothes-hanging rod, one or more drawers, and/or other unique and useful products, features, and compartments. Such an enclosure could be configured to store and transport other specific products as well. The enclosure could be a toolbox, a cooler, house a portable compressor, or other use-specific arrangement.

Although certain transport devices, mounting methods, and mounting components and accessories have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A transport device for coupling to a hitch of a vehicle, the transport device comprising:
a frame configured to carry an object;
a base on a portion of the frame and located to contact a support surface; and
a hitch mount carried by the frame and arranged so that the base can rest on the support surface and the hitch mount can be positioned adjacent to and contact a coupler of the hitch on the vehicle,
whereby the transport device can then be pivoted on the coupler about the hitch mount to raise the base off the support surface and then be secured to the hitch.

2. A transport device according to claim 1, wherein the base includes one or more wheels mounted to the frame.

3. A transport device according to claim 1, wherein the frame includes a platform arranged with the base at one end of the platform and a handle at an opposite end of the platform.

4. A transport device according to claim 1, wherein the hitch mount includes a tube connected horizontally to the frame, the tube having an open end configured to receive the coupler therein when secured to the hitch.

5. A transport device according to claim 4, wherein the tube has a circular cylinder wall and wherein a portion of the wall at the open end is removed creating an entry upward into the tube for contacting the hitch.

6. A transport device according to claim 1, wherein the hitch mount includes a rotatable disc carried outboard of the frame and rotatable about an axis, a portion of the disc being configured to be lowered onto or into the coupler of the hitch to connect the hitch mount to the coupler.

7. A transport device according to claim 1, wherein the hitch mount includes a bit carried on the frame and rotatable about an axis, the bit being configured to be lowered onto or into the coupler of the hitch to connect the hitch mount to the coupler

8. A transport device according to claim 1, wherein the transport device is aligned sideways when positioned adjacent the coupler and then slides onto the coupler after being pivoted to raise the base.

9. A transport device according to claim 8, wherein the hitch mount is a horizontal tube carried under the frame.

10. A towable transport system comprising:
a hitch adapter connected to a hitch receiver of a vehicle; and
a transport device having a frame configured to carry an object, a wheel carried on the frame, and a hitch mount carried by the frame, the wheel arranged to roll the transport device along a support surface, the hitch mount configured to engage the hitch adapter when positioned adjacent one another,
whereby the transport device can be pivoted on the hitch adapter about the hitch mount to a wheels-up orientation thereby positioning the transport device above the support surface and then can be secured to the hitch adapter.

11. A transport system according to claim 10, wherein the hitch adapter has a fitting that slides into the hitch receiver of the vehicle.

12. A transport system according to claim 10, wherein the hitch adapter has a coupler configured to connect to a portion of the hitch mount prior to pivoting to the wheels-up orientation.

13. A transport system according to claim 10, wherein the hitch adapter has a coupler on which the hitch mount slides after pivoting to the wheels-up orientation.

14. A transport system according to claim 10, wherein the hitch adapter includes an elongate cylindrical coupler projecting from a fitting that is connectable to the hitch receiver.

15. A transport system according to claim 14, wherein the hitch mount is a tube carried horizontally on the frame, the tube having an open end for receiving the coupler therein.

16. A transport system according to claim 15, wherein the tube has a cylindrical wall with a segment cut away at the open end for contacting a free end of the coupler when the transport device is positioned adjacent the coupler.

17. A transport system according to claim 10, wherein the hitch adapter is height adjustable.

18. A transport system according to claim 17, wherein the hitch adapter has a coupler connected to a fitting connectable to the hitch receiver, the coupler being height adjustable relative to the fitting.

19. A transport system according to claim 10, wherein the hitch adapter has a chuck carried on an end of a fitting connectable to the hitch receiver, and wherein the hitch mount has a bit or block shaped to be lowered into the chuck before pivoting to the wheels-up orientation.

20. A method of mounting a transport device to a vehicle hitch, the method comprising the steps of:
providing a hitch mount on the transport device;
positioning the transport device so that the hitch mount is adjacent the vehicle hitch with a base of the transport device resting on a support surface;
moving the hitch mount into contact with a coupler of the vehicle hitch;
pivoting the transport device on the coupler about the hitch mount to elevate the base off of the support surface with the entire transport device above the support surface; and
securing the transport device to the vehicle hitch.
